(19) United States
(12) Patent Application Publication
(10) Pub. No.: US 2004/0172484 A1
(43) Pub. Date: Sep. 2, 2004

(54) Device-specific communicating between a transmitting device and a receving device

(76) Inventors: Gudmundur Hafsteinsson, Reykjavik (IS); Georg Ludviksson, Reykjavik (IS)

Correspondence Address: BIRCH STEWART KOLASCH & BIRCH, PO BOX 747, FALLS CHURCH, VA, 22040-0747, US

(21) Appl. No.: 10/682,037

(22) Filed: Oct. 10, 2003

Related U.S. Application Data
(63) Continuation-in-part of application No. 09/824,675, filed on Apr. 4, 2001.
(60) Provisional application No. 60/194,695, filed on Apr. 5, 2000.

(30) Foreign Application Priority Data
Apr. 5, 2000 (IS) IS 5428
Oct. 11, 2000 (IS) IS 5658

(51) Int. Cl. G06F 15/16

(52) U.S. Cl. 709/246; 709/203; 709/230; 715/523

(57) ABSTRACT

The present invention relates to a system and a method for communication of data between a WEB server and a mobile device equipped with a browser, such as a WAP mobile phone. The invention further relates to a method of dynamically, cheaper and faster conversion of data between a first and a second format compliant to the WEB server and the device.

### FIELD OF THE INVENTION

The present invention relates to a system and a method for communication of data between a WEB server and a mobile device equipped with a browser and mobile Internet capabilities, such as a WAP-compliant mobile phone. The invention further relates to a method of dynamic, cheap and fast conversion of data between a first and a second format compliant to the WEB server and the device.

### BACKGROUND

Primarily due to differences in data formats there are currently no means for reading data comprised in e.g. an HTML WEB page from most browsers in mobile devices. In order to access WEB page information from a WAP phone, the WEB pages has to be converted. Today the owner of a WEB page typically selects specific data from the WEB page that he wants to make accessible from a WAP phone. The data is then converted and a new data file containing the converted data is created. When a WAP phone customer enters the specific WEB page, it is in reality the data file containing the converted data that is entered.

Due to the duplication of the WEB page information, two data files having different content, even though they disclose the same information, have to be updated. This is both costly and time consuming. Moreover the risk of faults is higher given that two pages must provide identical information in different formats.

Currently there exist methods to convert source data, such as web pages, into a general or device specific formats compatible with browser applications in mobile devices. Existing methods, however, generally suffer from drawbacks. Some methods are based on fully automatic or general conversion methods, meaning that certain data formats (e.g. web pages for desktop browsers) are converted to a data format suitable for display in mobile devices based on totally general (not context or application specific) conversion rules. This method has proven to often give poor results, except for the simplest cases since it is currently very hard or even impossible for such general conversion rules to always be able to deduct what parts of specific content are relevant enough to include in the second data format. To overcome this limitation there are also known methods, which offer application developers to manually define the transformation for each context or application. While this method offers full flexibility it is generally time consuming and therefore expensive.

### SUMMARY OF THE INVENTION

It is an object of the present invention to allow transfer of data from a data source to devices with limited processing and display capabilities. A unique method for conversion of data formats from source data format into device specific format, without having two different pages with the same information is presented. The present invention accomplishes the conversion by uniquely combining general and context specific conversion methods to offer conversion, which is flexible and yet minimizes the need for manual intervention by an application developer.

Accordingly the present invention relates to a method for communicating between a transmitting device and a receiving device, the communication comprising conversion of source data in a first format as output from the transmitting device into a second format to be received by the receiving device. The conversion is separated into two steps, where the first step is based on manually created context or application specific conversion rules, defined by an application developer, resulting in an intermediate, device-independent, standardized format and where the second step is based on general, device specific, conversion rules transforming the intermediate, standardized intermediate format into a device-specific, second data format suitable for display in a mobile device, which requests the content.

Furthermore since the intermediate, standardized, data format is device-independent this means that the developer of the application does not have to worry about the characteristics of particular types of devices and the end result (after the automatic, second, general conversion step is applied) is still a device-specific version of the data tailored to meet the capabilities of the particular device which requests the content.

### DETAILED DESCRIPTION OF THE INVENTION

In the first aspect of the present invention a method for communicating between a transmitting device and a receiving device is disclosed, wherein the communication is initiated by a request for a data from a data source, and the communication comprising conversion of source data in a first format as output from the transmitting device into a second, device-specific format to be received by the receiving device. Specifically the method comprises the steps of inline:

receiving data in the first format from the server,

converting the source data from the first format into data in the second format where the conversion is separated into a two part process and is comprised of at least the following two separated steps

converting the data from the first format into an intermediate, device-independent, standardized format using content- or application-specific conversion rules, manually defined for each application, relating the first format to the standardized, intermediate format.

converting the data in the intermediate, device-independent, standardized format into a device-specific, second format using general conversion rules relating the intermediate format to the device-specific, second format

Optionally, if beneficial, prior to converting the source data into a standardized, intermediate format, the source data may be processed by a pre-processor, which converts the source data format into a more standardized source data format to make it more suitable for further transformation. The preprocessing step, if applied, is automatic and based on general conversion rules and has the sole purpose of making the source data more suitable for further processing.

All of the above-mentioned conversion steps could be performed by means of a database search routine where the content of the database is the conversion rules. The conversion rules comprises relations between the data in the first format and data in the second format and could be performed over more than one conversion step by associating the data in the first format with conversion rules of more than one set of conversion rules.

If the conversion is a two-step conversion applied after preprocessing the source data, the preprocessing step could comprise conversion rules that convert the first format into a legal, standardized format by associating the data in the first format with rules relating to the legal, standardized format. The legal format could be a format such as XML or XHTML. The first conversion step, applied after the preprocessing step, could comprise conversion rules that convert the legal format into an intermediate, device-independent format, such as XML or XHTML, by means of context-specific conversion rules which relate the preprocessed legal data format with an intermediate data format containing all the relevant content given the context or application being defined.

The second conversion step could comprise selection rules that convert the intermediate data format into a second device-specific format such as WML by associating the data in the intermediate format with rules relating to the second format. The two-step conversion has the advantage of enabling a separation between the manual selection of the relevant content of the source data and the conversion of that content into a device-specific (e.g. WML) format into two separate conversion rule databases.

The communication is initiated by means of parameters that are passed in as a part of the request wherein said parameters are for selection of the conversion and selection rules. The request for data can also concern data from more than one data source. As an example data may be selected based upon the technical capabilities of the device or data may be selected based upon a desired reduction of the information to be communicated. If a user of a mobile device requests data from a WEB server, the parameter could comprise a list of technical features of the mobile phone, e.g. that colors in graphical images cannot be displayed and the amount of communicated data therefore could be reduced. If an owner of an Internet web page only wants to communicate certain parts of the page the parameter could comprise a list of data fields of the Internet home page to be converted. In that way the amount of data to be converted and transmitted between the communication parties could be reduced and the conversion could be adapted for a specific purpose.

In the present context “Source data” can be any data external to the system, such as any HTML data obtained from a web server.

The term “Legal, standardized format” (result of preprocessing) refers to result of converting source data (such as irregular HTML data) into a more standardized format for the sole purpose of making it more suitable for further processing. This typically involves converting irregular HTML into xHTML or XML, an XML-based version of the same HTML. No content selection or device adaptation happens in this step.

In the present context the term “intermediate, device-independent, standardized format” refers to result of first, manual, conversion step, where this format is the result of applying context specific conversion rules for the purpose of selecting the relevant (according to the context or application being developed) content or data from the source data and also, to a certain extent, to format the content in such a way as too suit generic small displays and capabilities of mobile devices. The result is an intermediate format in XML or XHTML. It is standardized (based on a relatively rigid specification) so that general device-specific conversion rules can be applied to it to tailor the intermediate device-independent format to suit the capabilities of particular types of devices.

The term “content-specific selection rules” refers to content, application or context-specific selection rules being selection rules that are based on knowledge of the particular content being transformed. An example would be to select the most important information from a web page and discard the rest, i.e. it typically involves selecting only part of the source data, based on the developer's judgment regarding what parts of it should be accessible from a mobile device.

In the present context the term “manually created” means that the conversions are created per-application by a developer having knowledge of the content being converted.

The term “Device-specific” refers to device specific conversion rules are based on information about many different types of devices and are able to convert the intermediate, device-independent format into a device specific version suitable for display in a certain type of device. As an example when a user requests content with a WAP browser in a Nokia 7650 device, the conversion will attempt to convert the intermediate device-independent format into a version suitable for the capabilities of this particular device and browser. The request will generally contain information about the device and browser type and this information, in conjunction with a database of information about the capabilities of many types of devices, is enough to enable a general and automatic conversion of the intermediate data format into a device specific format.

The term “general rules” refers to general conversion rules, which are general in the sense that they don't rely on content or application specific information. I.e. it means the every type of content can be automatically converted, without any developer intervention, as long is it adheres to the specifications of the intermediate format.

In an embodiment of the present invention the method includes a process where the source data is translated into a general or legal format prior to the conversion by associating the data in the first format with general rules relating to the legal format

In another embodiment of the present invention the content-specific selection rules insert content-dependent hints into the intermediate, device-independent format, which may be used by the general conversion rules in later steps to improve the quality of the general, device-specific conversion

In the present context the term “content-dependent hints” refers to pieces of information, optionally inserted by the developer into the intermediate format, that will aid the device-specific, automatic and general second step to better accomplish its conversion. This might include information about what data pieces belong together, what parts of the content are more important than others or suggestions that in one way or another provide the second, automatic conversion step with information regarding how it may or may not format the content when tailoring it to suite the needs of specific devices. Those hints are however rarely binding for the second step since it needs a certain degree of flexibility to be able to adapt the intermediate, device-independent format to a wide variety of device types with vastly different capabilities.

The term “device-independent format” refers to any data format, which contains all the relevant content (for the context or the application in question), and it might also be formatted to a certain extent in a generic way. It is, however, device-independent in the sense that it is not known what type of device or browser it will be adapted to. The format must therefore be generic enough to make adaptation to specific devices possible. Therefore, only the most general assumptions about capabilities of the requesting devices may be inherent in the intermediate format.

In an embodiment of the present invention the general conversion from the intermediate, device-independent format into a device specific, second format is performed over more than one conversion step by associating the data in the intermediate format with general conversion rules of more than one set of conversion rules. The general conversion from the said intermediate format into a device specific, second format is performed in two conversion steps as follows:

first converting the intermediate device-independent data format into a general version of a specific type of markup language data format

next converting the data in said general version of a specific type of markup language data format into a device-specific version of a specific type of markup language data format

Furthermore, the conversion from the legal format to the device-independent, intermediate format is based on transformations built using a development tool, which may have a graphical user interface.

In the present context the term “general version of a specific type of markup language data format” can mean a general version of Wireless mark-up language (WML), i.e. WML that is generic in the sense that it makes no assumption about the type of WML browser, which will request it.

The term “device-specific version of a specific type of markup language data format” mean fro example a version of WML that has been optimized or tailored for a specific type of WAP device/WML browser, such as Nokia 6310 WML browser. This might involve making sure the WAP pages are not larger than what this type of device-browser combination can handle. Images larger than what a specific type of browser-device combination can properly display might also be made smaller or omitted from the device-specific version.

In the present context the term “development tool” refers to a standalone piece of computer software, preferable with a graphical user interface (GUI), that will aid a developer of an application to define, create, test, preview and deploy his application. In particular a development tool is need to help the developer define the context-specific, conversion rules for his application that need to be manually created by the developer.

“Graphical user interface” is well known in the art such as any type of common GUI interface that will aid the developer with visual representations of the data being worked on.

In an embodiment of the present invention the legal format is XML and the intermediate, device-independent format is XML-based

In an embodiment of the present invention the transmitting device is a database and wherein the first format is a format of that device.

The transmitting device can serve as a receiving device and vice versa. As an example the transmitting device could be an Internet web server and the receiving device a mobile device with a WAP browser, in which case the formats could be HTML and WML respectively. In the present context the transmitting device can be selected from the domain of but not limited to mobile devices.

In another embodiment of the present invention the transmitting device is a WEB server, wherein the first format is a source format of WEB servers. Furthermore, the receiving device is a mobile device with Internet capabilities and equipped with a browser, wherein the second format is a format suitable for the browser in that device. In a specific embodiment of the present invention the receiving device is a WEB server, wherein the second format is a source format of WEB servers

In the present context the term “WEB server” refers to a server, residing on the Internet, capable of serving requests made in the HTTP protocol. Generally means serving content in HTML format but it might be other types of content as well.

In one embodiment of the present invention the request for data concerns data from more than one separate data sources (e.g. 2 unrelated web servers) can be combined to form the source date, which is then adapted to the mobile device/browser requesting the content.

According to another aspect the present invention relates to a system for wireless communication of data between an external content source and a mobile device with Internet capabilities and equipped with a browser, comprising a converter for inline conversion of data in a first format as output from the external content source into a second, device-specific format to be received by the device or for conversion of data in the second, device-specific format into data in the first format, said system comprising:

receiving means for receiving the data in the first format,

a database for storing and retrieving a conversion scheme,

a converter for converting the data based on a conversion scheme comprised of at least the following two separated conversion steps:

converting the data from the first format into an intermediate, device-independent format using content-specific selection rules, manually created for each application, relating the first format to the intermediate format.

converting the data in the intermediate format into a device-specific, second format using general rules relating the intermediate format to the device-specific, second format

and transmitting means for transmitting the converted data

The converter for inline conversion of data in a first format could be specifically adapted for conversion of WEB server data into a second format to be received by the device such as a mobile device or for conversion of data in the second format into data in the first format. The converter may be a processor adapted in a computer system of any kind, such as in a PC. The two data formats could be HTML and WML or any other formats adapted for the two platforms—the WEB server and the WAP device. Inline conversion means that the conversion takes place when a mobile device requests the content, so that the client receives information comprised in the actual WEB page and not information from the WEB page that has earlier been converted.

According to a preferred embodiment of the invention the converter may comprise a computer database wherein output data generated in response to input data is controlled by an identifier of the WEB server data. The identification could be based on a user-defined relationship between a number of WEB pages and matching schemas comprising conversion rules for the WEB pages. When a WEB page owner decides to enable conversion of the WEB page into a WAP device compliant format such as WML

The conversion rules may be grouped into the schemas e.g. based on various versions of the two formats e.g. various versions of HTML, XML or WML or they may be grouped based on the type of information being converted.

According to a preferred embodiment of the invention the first format is HTML, XML or a XML compliant format and the second format is WML or a similar a WAP compliant format. If the WEB page is in HTML the HTML could preferably be pre-converted or pre-processed into XML and then the XML format could be converted into WML based on a two-step conversion process.

### BRIEF DESCRIPTION OF THE DRAWINGS

A preferred embodiment of the invention will now be described in details with reference to the drawing in which:

FIG. 1 shows a functional diagram of a system server,

FIG. 2 shows a system Layout diagram as an example of how the server could be used to implement a three-stage transformation.

### EXAMPLES

### Example 1

System for Conversion of Data Formats for Exchange of Data Between a WEB Server and a WAP Device.

This system makes it quicker and less expensive than currently possible systems to publish HTML content in WAP device. By use of the system, any existing HTML content can be transformed to the WAP device's native format WML. Therefore virtually any service currently available on the Internet can be made available to WAP devices in a matter of a few hours or days.

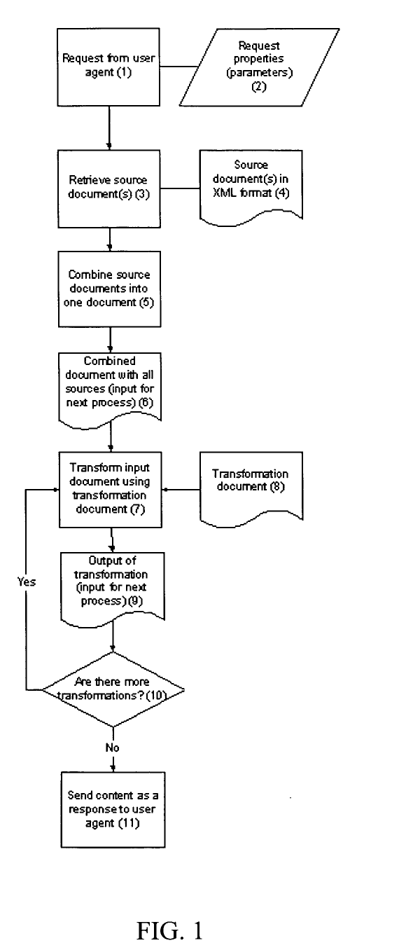

The system acts as a filtering proxy, meaning that it processes and alters all requests from the WAP device and all responses from the HTML web server. No alterations are needed on the server as long as it is at least HTTP 1.0 compliant and as long as the WAP device is compliant it should be able to display the response given from the system (since it is fully compliant with the WAP standard as defined by the WAP forum). A general overview is shown in FIG. 1.

The functionality's of this system is shown in FIG. 1. The steps may be grouped into several parts, whereby the first part is the request to the server software 1 which is usually an HTTP request, but which may also originate from other sources. Parameters 2 are passed in as part of the request and can be used to decide what document to transform, etc. Currently the parameters are used to decide which source document(s) to retrieve and how to transform them (i.e. which transformation documents to use). Each transformation may additionally define custom parameters that should be passed to it in the request. The source document retrieval 3 can take documents from any external data source. Current implemented sources are through HTTP from another web server, and through local I/O from the file system, but might also include databases and other 3rd-party systems such as content management systems or any other external data format. The source document 4 must be in legal XML format, but for non-XML documents (such as HTML) there may be a pre processor (not shown explicitly on the diagram), which converts the input into a legal XML document in some well-defined way.

The server supports multiple sources within one request. The multiple sources 5 are combined into one XML document, which allows access to all the sources in one document. The combined document 6 is the input for the next process. The input document is either the combined source documents directly, or the output from a previous transformation process. It is transformed by transformation process 7.

One example of such transformation process is to apply an XSL transformation style sheet document. The type of the transformation document 8 depends on the transformation process. Which document is used depends on both the configuration of the transformation process and the parameters in the request. One example of such a configuration is to use one request parameter to name a document in the file system.

Another example is to use the user agent name (part of the request) to decide what transformation to use. The transformation document storage is independent of the transformation process hence these documents may be stored in any preferred fashion, e.g. in a file system or a database. The output from the transformation 9 is either the final result or the input to another transformation process. The configuration decides whether there are more transformation processes 10. Each transformation process has its own unique configuration and behaves in a certain predefined way (e.g. one can transform based on a request selected transformation document and another one can transform based on the user agent name). Generally the transformation is at least a two step process where the first step is based an a developer-defined context-specific conversion rules resulting in an intermediate device-independent, standardized format and whereas the second step is based on general conversion rules resulting in a device-specific version of the requested content. The result is sent to the user agent as a response 11 to its request.

### Example 2

Implementation of a Three-Stage Transformation of Data

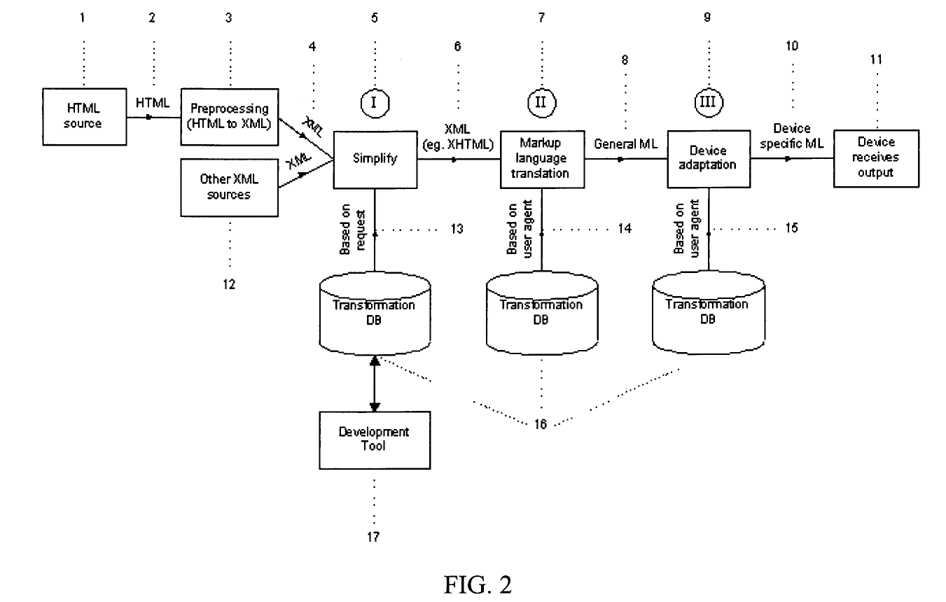

FIG. 2 shows a System Layout diagram as an example of how the server could be used to implement a three-stage transformation, where each stage is marked with I-III. Note that a preprocessor might be applied before any of the three conversion steps is applied.

The first step of a three-stage transformation is an extraction of all relevant information into a document in device-independent, standardized format (usually a specific XHTML format based on general XHTML format) using context-specific conversion rules defined by an application developer. Then that document is transformed in a general form in another markup language (for example WML, CHTML, HTML or XHTML) based on general conversion rules and finally that document is transformed into device-specific content adapted to the user agent (for example WML which is specifically adapted for the Nokia 7110 WAP browser, optimizing for its display and working around its bugs). The third step is also, generally, based on general conversion rules.

Individual steps in the Layout diagram have the following function:

The HTML source 12 may be anywhere, for example on an HTTP web server. The HTML document 13 is transmitted as-is. Note that HTML documents are not legal XML documents. The HTML document is converted to legal XML 14 before being presented to the transformation 27 process. The input into the first stage of the transformation 15 is an XML document composed of the XML inputs, which have no predefined document type. The first stage 16 of the transformation extracts relevant information from the source document. The output 17 from the first stage is a predefined XML format, for example XHTML, which contains the relevant information from the XML input source. The second stage 18 transforms 27 the output from the first stage into a specific markup language (not device-specific). An example of this would be transforming to WML. This step may be regarded as a markup language translation. The general ML 19 is a specific markup language (e.g. HTML, WML, CHTML, XHTML etc.), but not adapted to known implementation details of any specific device. The third stage 20 transforms 27 the general form of the markup language and adapts it the specific user agent (device) doing the request. An example of adaptation is to divide up text elements to fit in the user agent device screen, or to work around a flawed user agent ML implementation 21. The device-specific markup language 21 is a result, which has been adapted to the specific user agent doing the request.

The user agent receives the output 22. Other sources 23 can be used to generate the XML content. Examples of such sources are databases, content management systems, file systems, etc. Which transformation document to use is determined by the user request 24 (e.g. by means of a request parameter)? Which transformation document to use is determined by the name of the user agent 25, 26 (there exists a mapping between user agent names and what transformation document to use)? The transformation document database might, for example, be a local file system or a database. The transformation process and the storage mechanism are mutually independent, hence the storage mechanism may be changed transparently.

A system development tool 28 may be used to define transformations for the first stage. These transformations may also contain hints for the third-stage transformations, but these hints are then necessarily dependent on that transformation.

1. A method for communicating between a transmitting device and a receiving device, wherein the communication is initiated by a request for specific data from a data source, and the communication comprising conversion of source data in a first format as output from the transmitting device into a second, device-specific format to be received by the receiving device, said method comprising the steps of inline:
receiving data in the first format from the server,
converting the source data from the first format into data in the second format where the conversion is a two step process and is comprised of at least the following two separated steps
converting the data from the first format into an intermediate, device-independent, standardized format using content-specific conversion rules, manually created for each application, relating the first format to the intermediate format
converting the data in the intermediate format into a device-specific, second format using general rules relating the intermediate format to the device-specific, second format
forwarding the data in the second format to the client

2. A method according to claim 1, wherein the source data is translated or preprocessed into a general or legal format prior to the conversion by associating the data in the first format with general rules relating to the general or legal format

3. A method according to claim 1 or 2, wherein the said content-specific selection rules insert content-dependent hints into the intermediate, device-independent format which may be used by the general conversion rules in later steps to improve the quality of the general device-specific conversion

4. A method according to claims 1,2 or 3, wherein the general conversion from the said intermediate format into a device specific, second format is performed over more than one conversion step by associating the data in the intermediate format with general conversion rules of more than one set of conversion rules

5. A method according to claims 1, 2 or 3, wherein the general conversion from the said intermediate format into a device specific, second format is performed in two conversion steps as follows:
first converting the intermediate device-independent data format into a general version of a specific type of markup language data format
next converting the data in said general version of a specific type of markup language data format into a device-specific version of a specific type of markup language data format

6. A method according to any of the preceding claims, wherein the conversion from the legal format to the device-independent, standardized, intermediate format is based on transformations built using a development, perhaps with a graphical user interface (GUI)

7. A method according to any of the preceding claims, wherein the legal format is XML

8. A method according to any of the preceding claims, wherein the intermediate, standardized, device-independent format is XML-based.

9. A method according to any of the preceding claims, wherein the transmitting device is a database and wherein the first format is a format of that device

10. A method according to any of the preceding claims, wherein the transmitting device is a WEB server and wherein the first format is a source format of WEB servers

11. A method according to any of the preceding claims, wherein the receiving device is a mobile device with Internet capabilities equipped with a browser and wherein the second format is suitable for display in the browser.

12. A method according to any of the preceding claims, wherein the receiving device is a WEB server and wherein the second format is a source format of WEB servers

13. A method according to any of the preceding claims, wherein the request for data concerns data from more than one data source

14. A system for wireless communication of data between an external content source and a mobile device with Internet capabilities equipped with a browser, comprising a converter for inline conversion of data in a first format as output from the external content source into a second, device-specific format to be received by the device or for conversion of data in the second, device-specific format into data in the first format, said system comprising:
receiving means for receiving the data in the first format,
a database for storing and retrieving a conversion scheme,
a converter for converting the data based on a conversion scheme comprised of at least the following two separated conversion steps:
converting the data from the first format into an intermediate, device-independent format using content-specific selection rules, manually created for each application, relating the first format to the intermediate format.
converting the data in the intermediate format into a device-specific, second format using general rules relating the intermediate format to the device-specific, second format
and transmitting means for transmitting the converted data
